(19) United States
(12) Patent Application Publication
(10) Pub. No.: US 2006/0184593 A1
(43) Pub. Date: Aug. 17, 2006

(54) MULTI-COVER DEVICE

(76) Inventor: Yung-Chin Cho, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,590

(22) Filed: Feb. 14, 2006

(30) Foreign Application Priority Data
Feb. 16, 2005 (TW) 094104539

(51) Int. Cl. G06F 1/16

(52) U.S. Cl. 708/100

(57) ABSTRACT

A multi-cover device positioned on a main body is disclosed. The multi-slide device includes an outer cover, an inner cover disposed on the main body and positioned inside the outer cover, and a latch device positioned between the inner cover and the outer cover for controlling the outer cover to move with or without the inner cover.

### BACKGROUND OF THE INVENTION

1. Field of the Invention

The present invention relates to a slide device, and more specifically, to a multi-cover device where an outer cover is separate from an inner cover and can move individually.

2. Description of the Prior Art

Modern society has become an information society in which information communication systems are highly developed and portable electronic devices are at the forefront of the communications market. Convenient, lightweight and wireless communication devices such as mobile phones have become prevalent in everyday life. Information can be exchanged whenever and wherever. The recent trend in mobile phone design is increasingly smaller size. Therefore, enabling a user to use a portable electronic device more conveniently becomes an important issue of portable electronic device design.

A slide device utilized in a portable electronic device (i.e. a digital camera or a mobile phone), according to a related art in the market, consists of a single slide. The related art slide only provides certain functions and cannot provide additional functions to be utilized by the user. In other words, the related art slide only serves as a part of the housing and nothing more. Convenience and versatility are primary considerations for a consumer. As an example, many people carry pocket mirrors or have to find mirrors in public places, which can be an inconvenience. If a portable electronic device provides the above-mentioned additional function(s) using a slide device, the portable electronic device has more utilization flexibility.

### SUMMARY OF THE INVENTION

One of the objectives of the claimed invention is therefore to provide a multi-cover device to solve the above-mentioned problem.

One of the objectives of the claimed invention is therefore to provide a multi-cover device positioned on a main body. The multi-cover device comprises: an outer cover; an inner cover disposed on the main body and positioned inside the outer cover; and a latch device positioned between the inner cover and the outer cover for controlling the outer cover to move with or without the inner cover.

The multi-cover device according to the claimed invention comprises an inner cover and an outer cover, wherein the outer cover can be separate from the inner cover allowing the outer cover to move individually. Therefore a surface of the inner cover can be utilized for providing additional functions. For example, the surface of the inner cover can be a reflective surface that could be utilized as a mirror. Hence, the multi-cover device according to the claimed invention can have additional functions lacking in the related art slide device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a multi-cover device positioned on a main body according to the present invention.

FIG. 2 is an exploded diagram of the multi-cover device shown in FIG. 1.

FIG. 3 is a flowchart describing fabrication of the components shown in FIG. 2 of the multi-cover device shown in FIG. 1.

FIG. 4 is a diagram of a first embodiment in which the outer cover and the inner cover of the multi-cover device shown in FIG. 1 move together.

FIG. 5 is a diagram of a second embodiment in which the outer cover and the inner cover of the multi-cover device shown in FIG. 1 move together.

FIG. 6 is a diagram of an embodiment in which the outer cover of the multi-cover device shown in FIG. 1 moves individually.

FIG. 7 is a cross-section diagram of the inner cover and the outer cover of the multi-cover device shown in FIG. 1 before the inner cover and the outer cover are moved apart.

FIG. 8 is a cross-section diagram of the inner cover and the outer cover of the multi-cover device shown in FIG. 1 after the inner cover and the outer cover have been moved apart.

FIG. 9 is an enlarged diagram of the inner cover shown in FIG. 1.

FIG. 10 is an enlarged diagram of the main body shown in FIG. 1.

### DETAILED DESCRIPTION

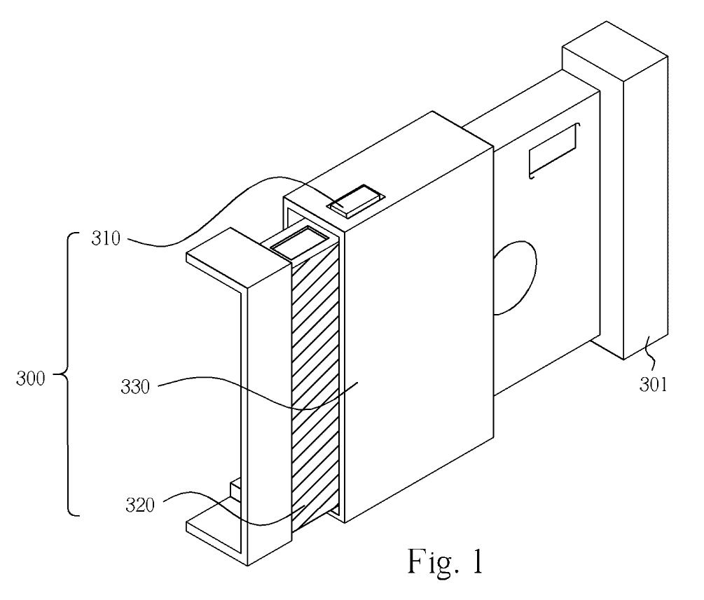

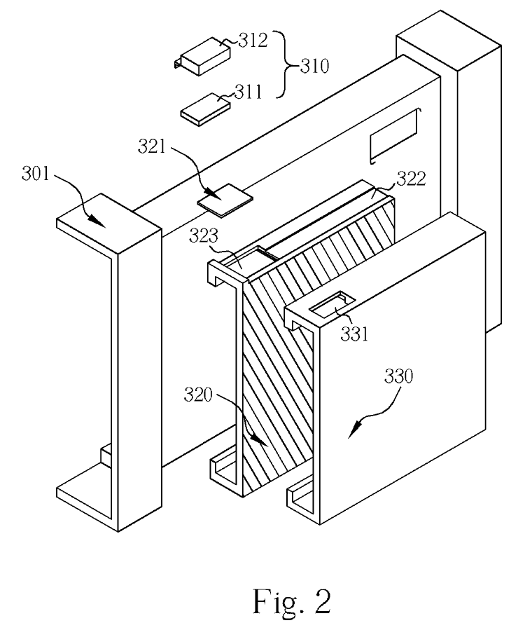

Please refer to FIG. 1 and FIG. 2. FIG. 1 is a diagram showing a multi-cover device 300 positioned on a main body 301 according to the present invention. FIG. 2 is an exploded diagram of the multi-cover device 300 shown in FIG. 1. As shown in FIG. 1, in the present embodiment, the multi-cover device 300 comprising a latch device 310, an inner cover 320 and an outer cover 330 is installed on a housing of a digital camera (in this embodiment, the multi-cover device 300 is positioned on the main body 301). It should be noted that the multi-cover device 300 is not limited to being installed on a digital camera. The multi-cover device 300 can be applied to any portable electronic devices, such as a mobile phone. As shown in FIG. 2, the movable inner cover 320 is disposed on the main body 301, and the inner cover 320 is positioned inside the outer cover 330. The movable latch device 310 is positioned between the outer cover 330 and the inner cover 320 for controlling the outer cover 330 to move with or without the inner cover 320. The latch device 310 comprises a slide key 312 and a magnet 311 positioned on the bottom of the slide key 312; that is, on the bottom of the device 310. As shown in FIG. 2, the inner cover 320 comprises a magnet 321 and a slot 322. The magnet 321 is positioned in an engaging portion 323 of one end of the slot 322, and the outer cover 331 comprises a first cavity 331. Please note that in the present embodiment, the magnetic field of the magnet 311 is opposite to the magnetic field of the magnet 321, which means a side of the magnet 311 facing a side of the magnet 321 are both North poles or both South poles, and therefore repel.

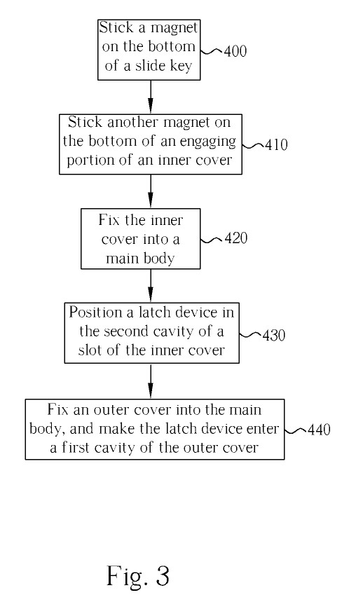

Please refer to FIG. 3. FIG. 3 is a flowchart describing fabrication of the components shown in FIG. 2 of the multi-cover device 300 shown in FIG. 1. The component fabricating flow of the multi-cover device 300 comprises the following steps:

Step 400: Stick the magnet 311 on the bottom of the slide key 312 using an object with glue property, such as double-sided sticky tape.

Step 410: Stick the magnet 321 on the bottom of the engaging portion 323 of the inner cover 320 using another object with glue property, such as double-sided sticky tape.

Step 420: Fix the inner cover 320 into the main body 301.

Step 430: Position the latch device 310 in the engaging portion 323 of the slot 322 of the inner cover 320.

Step 440: Fix the outer cover 330 into the main body 301, and make the latch device 310 (at this time the latch device 310 is installed in the engaging portion 323, and also in the slot 322) through the first cavity 331 of the outer cover 330.

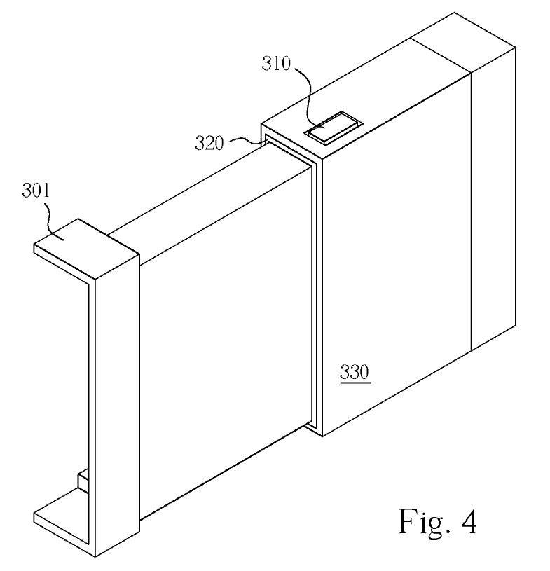

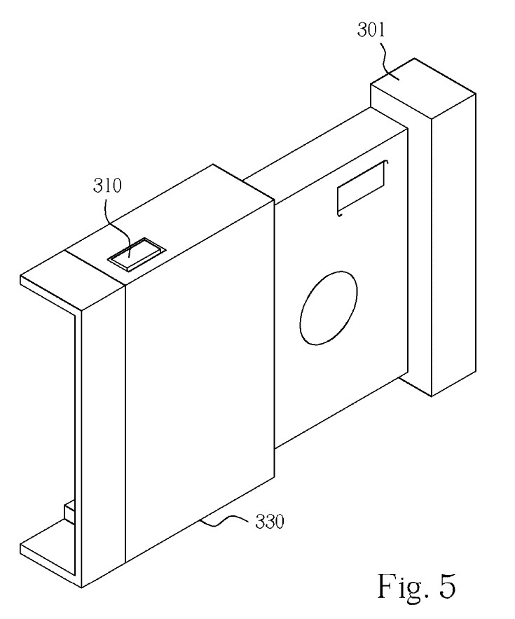

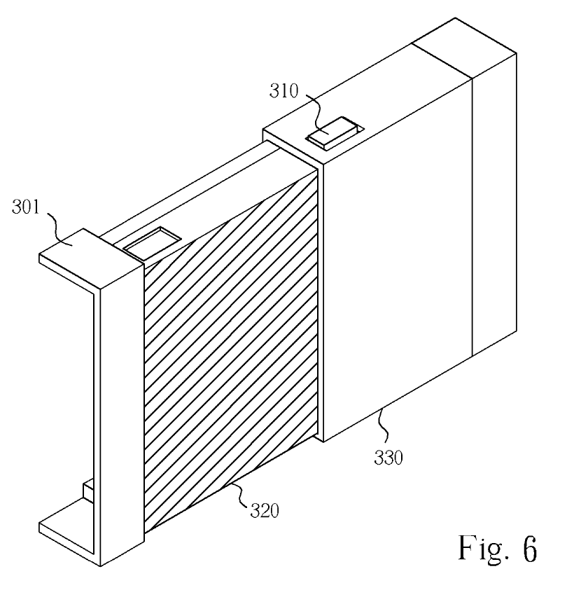

Please refer to FIG. 4 and FIG. 6. FIG. 4 is a diagram of a first embodiment in which the outer cover 330 and the inner cover 320 of the multi-cover device 300 shown in FIG. 1 move together. FIG. 5 is a diagram of a second embodiment in which the outer cover 330 and the inner cover 320 of the multi-cover device 300 shown in FIG. 1 move together. FIG. 6 is a diagram of an embodiment in which the outer cover 330 of the multi-cover device 300 shown in FIG. 1 moves individually. In FIG. 4 the inner cover 320 and outer cover 330 are simultaneously pushed to one end; in FIG. 5 the inner cover 320 and outer cover 330 are simultaneously pushed to the opposite end. At this time, functions of the multi-cover device 300 according to the present invention are similar to functions of a slide device according to the related art. In other words, the position of the multi-cover device 300 in FIG. 4 corresponds to a closed state so that components (i.e. a lens of a digital camera) of the main body 301 can be protected. The position of the multi-cover device 300 in FIG. 5 corresponds to an open state to allow the components (i.e. a lens of a digital camera) of the main body 301 to normally operate. In FIG. 6, the inner cover 320 and the outer cover 330 are apart, and at this time, a user can only move the outer cover 330 to use additional functions provided by the multi-cover device 300. In the present embodiment, a surface of the inner cover 320 is a reflective surface which can be formed by electroplating, evaporating or sputtering. Therefore, after the inner cover 320 and outer cover 330 are apart, the reflective surface of the inner cover 320 can be utilized as a mirror. The detailed description of a slide separating mechanism of the multi-cover device 300 according to the present invention is described as follows.

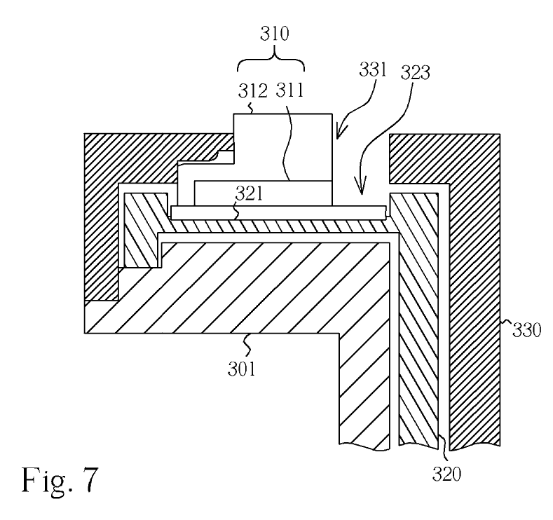

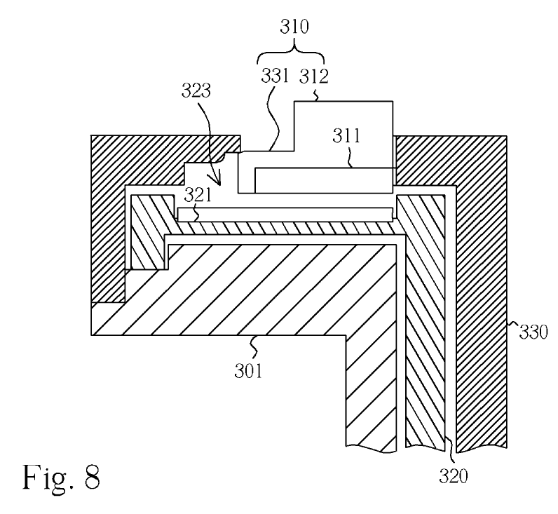

Please refer to FIG. 7 and FIG. 8. FIG. 7 is a cross-section diagram of the inner cover 320 and the outer cover 330 of the multi-cover device 300 shown in FIG. 1 before the inner cover 320 and the outer cover 330 are moved apart. FIG. 8 is a cross-section diagram of the inner cover 320 and the outer cover 330 of the multi-cover device 300 shown in FIG. 1 after the inner cover 320 and the outer cover 330 have been moved apart. In FIG. 7, the latch device 310 is at a first position while the outer cover 330 simultaneously moves together with the inner cover 320. In FIG. 8, the latch device 310 is pushed by a user and moves from the first position to a second position. At this time, the latch device 310 departs from the engaging portion 323 and moves in the slot 322 freely. In other words, when the latch device 310 is not fixed in the engaging portion 323 and a user moves the outer cover 330, the inner cover 320 cannot be driven to move by the latch device 310. Hence, now only the outer cover 330 can move individually, and the detailed operation is described as follows. When the user moves the latch device 310 to the first position, the latch device 310 engages the inner cover 320 and the outer cover 330 to move together by the engaging portion 323, which makes the inner cover 320 and the outer cover 330 move together. However, when the user moves the latch device 310 to the second position, a repelling magnetic force is formed between the latch device 310 and the inner cover 320 (the repelling magnetic force is generated using the magnets 311 and 321), and the latch device 310 is forced away from the engaging portion 323 to separate the inner cover 320 and the outer cover 330. Hence, the outer cover 330 can move without the inner cover 320.

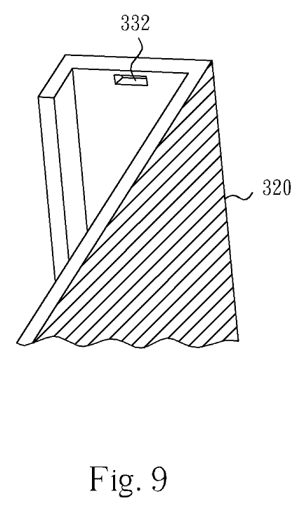

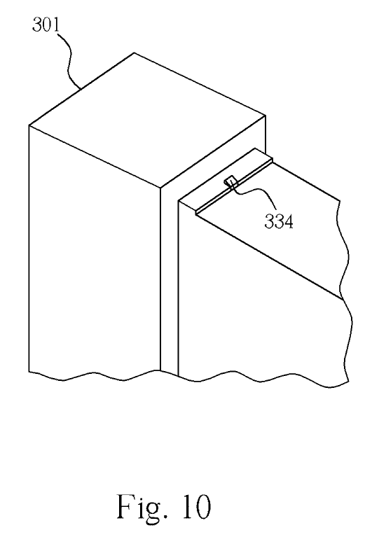

The latch device 310 is assumed to have already been moved to the second position by the user so that the outer cover 330 can be moved individually. However, in order to avoid a situation in which the friction between the inner cover 320 and the outer cover 330 causes the inner cover 320 to improperly move with the outer cover 330, in the present embodiment a fixing device is installed between the inner cover 320 and the main body 301. Please refer to FIG. 9 and FIG. 10. FIG. 9 is an enlarged diagram of the inner cover 320 shown in FIG. 1. FIG. 10 is an enlarged diagram of the main body 301 shown in FIG. 1. As can be seen from the diagram, a slit 332 is formed on a surface of the inner cover 320 where the surface of the inner cover 320 may contact with the main body 301, and a wedge 334 is positioned on a surface of the main body 301 where the surface of the main body 301 may contact with the inner cover 320. Therefore, when the inner cover 320 moves to a side of the main body 301, as shown in FIG. 5, the wedge 334 will wedge into the slit 332 so that an appropriate resistance force is provided to fix the inner cover 320 on the main body 301 when the outer cover 330 moves individually. It should be noted that the wedge 334 can also be installed on the inner cover 320, and the slit 332 can also be installed on the main body 301. Therefore, the goal of fixing the inner cover 320 can also be achieved, and any methods for achieving the goal of fixing the inner cover 320 are covered in the present invention.

In contrast with the related art, the multi-cover device according to the present invention comprises an inner cover and an outer cover, wherein the outer cover and the inner cover can be apart and the outer cover can move individually. Therefore, the surface of the inner cover can provide additional functions; for example, the surface of the inner cover can be utilized as a mirror. The multi-cover device according to the present invention can create additional functions lacking in the related art device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-cover device positioned on a main body, comprising:
an outer cover;
an inner cover disposed on the main body and positioned inside the outer cover; and
a latch device positioned between the inner cover and the outer cover for controlling the outer cover to move with or without the inner cover.

2. The multi-cover device of claim 1, wherein the inner cover comprises a slot, the outer cover comprises a first cavity, and the latch device is positioned in the slot and through the first cavity.

3. The multi-cover device of claim 2, wherein the slot further comprises an engaging portion, and when the latch device is in a first position, the latch device engages the inner cover and the outer cover to move together by the engaging portion; when the latch device is in a second position, the latch device departs from the engaging portion allowing the outer cover to move without the inner cover.

4. The multi-cover device of claim 3, wherein the main body comprises a fixing device, and when the inner cover moves to a fixing position, the inner cover is fixed to the fixing device.

5. The multi-cover device of claim 4, wherein the fixing device is a slit, the inner cover further comprises a wedge, and when the inner cover moves to the fixing position, the wedge is wedged in the slit.

6. The multi-cover device of claim 4, wherein the fixing device is a wedge, the inner cover further comprises a slit, and when the inner cover moves to the fixing position, the wedge is wedged in the slit.

7. The multi-cover device of claim 3, wherein the latch device and the inner cover are both magnetic, the magnetic field of the latch device is opposite to the magnetic field of the inner cover, and when the latch device moves to the second position, an repelling magnetic force is formed between the latch device and the inner cover, and the latch device is forced away from the slot to separate the inner cover and outer cover.

8. The multi-cover device of claim 2, wherein the latch device comprises a first magnet, and the inner cover comprises a second magnet.

9. The multi-cover device of claim 8, wherein the first magnet is positioned on the bottom of the latch device, and the second magnet is positioned in the slot.

10. The multi-cover device of claim 1, wherein a surface of the inner cover is a reflective surface.

11. The multi-cover device of claim 10, wherein the reflective surface is formed by electroplating, evaporating or sputtering.

12. The multi-cover device of claim 1, wherein the outer cover is installed and movable on the main body.

13. The multi-cover device of claim 1, wherein the outer cover is installed and movable on the inner cover.

14. The multi-cover device of claim 1, wherein the main body is a portable electronic device.

15. The multi-cover device of claim 14, wherein the portable electronic device is a digital camera.

16. The multi-cover device of claim 14, wherein the portable electronic device is a mobile phone.
